(19) United States
(12) Patent Application Publication
(10) Pub. No.: US 2024/0022447 A1
(43) Pub. Date: Jan. 18, 2024

(54) COMMUNICATION CONTROL METHOD AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/472,661

(22) Filed: Sep. 22, 2023

Related U.S. Application Data
(63) Continuation of application No. PCT/JP2022/013268, filed on Mar. 22, 2022.
(60) Provisional application No. 63/164,688, filed on Mar. 23, 2021.

(51) Int. Cl. H04L 12/18; H04W 74/08

(52) U.S. Cl. CPC H04L 12/189; H04W 74/0833

(57) ABSTRACT

A communication control method according to an embodiment is a communication control method used in a mobile communication system providing a multicast broadcast service (MBS) from a base station to a user equipment. The communication control method includes, by the user equipment, transmitting predetermined information to the base station in a random access procedure. The predetermined information indicates that the user equipment accesses the base station and thus receives multicast data from the base station.

### RELATED APPLICATIONS

The present application is a continuation based on PCT Application No. PCT/JP2022/013268, filed on Mar. 22, 2022, which claims the benefit of U.S. Provisional Patent Application No. 63/164,688 filed on Mar. 23, 2021. The content of which is incorporated by reference herein in their entirety.

### TECHNICAL FIELD

The present disclosure relates to a communication control method and a user equipment used in a mobile communication system.

### BACKGROUND OF INVENTION

In recent years, a mobile communication system of the fifth generation (5G) has attracted attention. New Radio (NR), which is a Radio Access Technology (RAT) of the 5G System, has features such as high speed, large capacity, high reliability, and low latency compared to Long Term Evolution (LTE), which is a fourth-generation radio access technology.

### CITATION LIST

### Non-Patent Literature

Non-Patent Document 1: 3GPP Technical specification “3GPP TS 38.300 V16.3.0 (2020-09)”

### SUMMARY

A communication control method according to a first aspect is a communication control method used in a mobile communication system providing a multicast broadcast service (MBS) from a base station to a user equipment. The communication control method includes, by the user equipment, transmitting predetermined information to the base station in a random access procedure. The predetermined information indicates that the user equipment accesses the base station to receive multicast data from the base station.

A communication control method according to a second aspect is a communication control method used in a mobile communication system providing a multicast broadcast service (MBS) from a base station to a user equipment. The communication control method includes, by a NAS layer of the user equipment, acquiring a start time of an MBS session, and, by the NAS layer, providing, based on the start time, a lower layer located below the NAS layer with a request for the user equipment to access the base station.

A user equipment according to a third aspect includes a processor configured to perform the communication control method according to the first aspect or the second aspect.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a correspondence relationship between a downlink Logical channel and a downlink Transport channel according to an embodiment.

FIG. 7 is a diagram illustrating a delivery method of MBS data according to an embodiment.

FIG. 8 is a diagram illustrating a multicast session join procedure according to an embodiment.

FIG. 9 is a diagram illustrating an operation example according to a first embodiment.

FIG. 10 is a diagram illustrating an operation example according to a second embodiment.

FIG. 11 is a diagram illustrating operation according to Variation 1 of the second embodiment.

FIG. 12 is a diagram illustrating operation according to Variation 2 of the second embodiment.

FIG. 13 is a diagram illustrating an outline of agreement regarding an MBS configuration.

FIG. 14 is a diagram illustrating a structure of a Delivery mode 1 configuration.

FIG. 15 is a diagram illustrating a structure of a Delivery mode 2 configuration.

### DESCRIPTION OF EMBODIMENTS

Introduction of multicast broadcast services to the 5G system (NR) has been under study. NR multicast broadcast services are desired to provide enhanced services compared to LTE multicast broadcast services.

The present disclosure is intended to provide a communication control method and a user equipment for achieving an enhanced multicast broadcast service.

A mobile communication system according to an embodiment is described with reference to the drawings. In the description of the drawings, the same or similar parts are denoted by the same or similar reference signs.

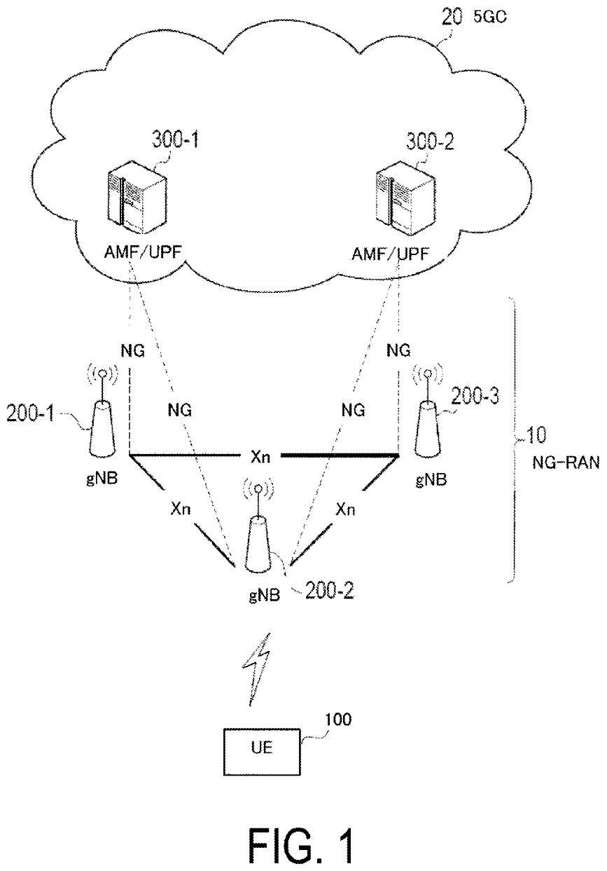

Configuration of Mobile Communication System First, a configuration of a mobile communication system according to an embodiment is described. FIG. 1 is a diagram illustrating a configuration of the mobile communication system according to an embodiment. This mobile communication system complies with the 5th Generation System (5 GS) of the 3GPP standard. The description below takes the 5 GS as an example, but Long Term Evolution (LTE) system may be at least partially applied to the mobile communication system. The sixth generation (6G) system may be at least partially applied to the mobile communication system.

As illustrated in FIG. 1, the mobile communication system includes a User Equipment (UE) 100, a 5G radio access network (Next Generation Radio Access Network (NG-RAN)) 10, and a 5G Core Network (5 GC) 20.

The UE 100 is a mobile wireless communication apparatus. The UE 100 may be any apparatus as long as the apparatus is utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and/or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or a plurality of cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency.

Note that the gNB can be connected to an Evolved Packet Core (EPC) corresponding to a core network of LTE. An LTE base station can also be connected to the 5 GC. The LTE base station and the gNB can be connected via an inter-base station interface.

The 5 GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

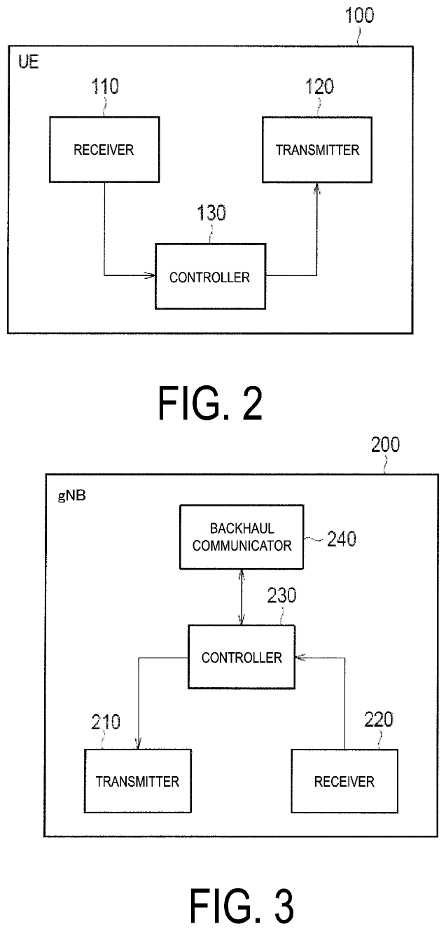

FIG. 2 is a diagram illustrating a configuration of the user equipment (UE) 100 according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal output by the controller 130 (a transmission signal) into a radio signal and transmits the resulting signal through the antenna.

The controller 130 performs various types of control in the UE 100. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

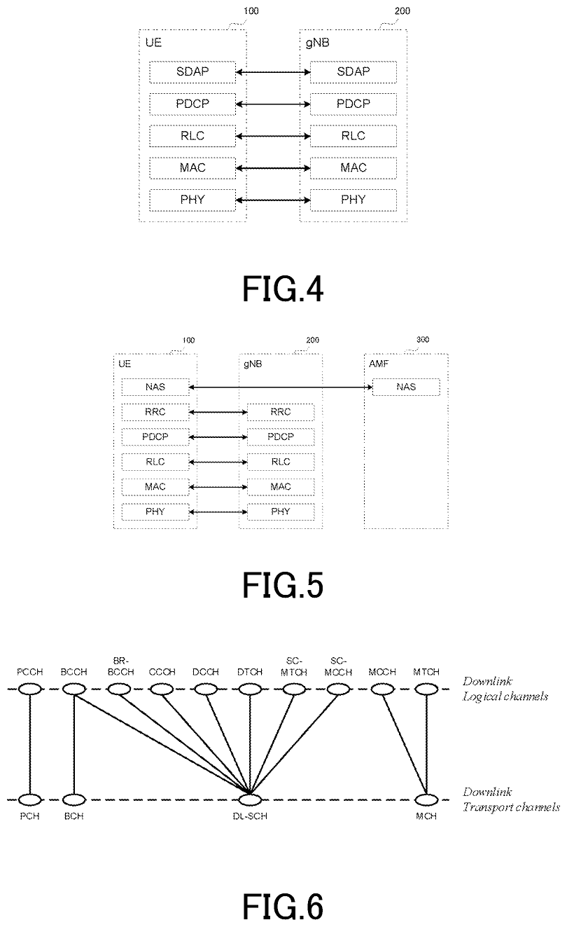

FIG. 4 is a diagram illustrating a configuration of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink, and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, reestablishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the RRC connection between the RRC of the UE 100 and the gNB 200 is suspended, the UE 100 is in an RRC inactive state.

The NAS layer which is positioned higher than the RRC layer performs session management, mobility management, and the like. NAS signaling is transmitted between the NAS layer of the UE 100 and the NAS layer of the AMF 300.

Note that the UE 100 includes an application layer other than the protocol of the radio interface.

MBS

An MBS according to an embodiment is described. The MBS is a service in which the NG-RAN 10 can provide broadcast or multicast, i.e., Point To Multipoint (PTM) data transmission to the UE 100. The MBS may be referred to as the Multimedia Broadcast and Multicast Service (MBMS). Note that use cases (service types) of the MBS include public security communication, mission critical communication, V2X (Vehicle to Everything) communication, IPv4 or IPv6 multicast delivery, Internet protocol television (IPTV), group communication, and software delivery.

MBS Transmission in LTE includes two schemes, i.e., a Multicast Broadcast Single Frequency Network (MBSFN) transmission and Single Cell Point-To-Multipoint (SC-PTM) transmission. FIG. 6 is a diagram illustrating a correspondence relationship between a downlink Logical channel and a downlink Transport channel according to an embodiment.

As illustrated in FIG. 6, the logical channels used for MBSFN transmission are a Multicast Traffic Channel (MTCH) and a Multicast Control Channel (MCCH), and the transport channel used for MBSFN transmission is a Multicast Control Channel (MCH). The MBSFN transmission is designed primarily for multi-cell transmission, and in an MBSFN area including a plurality of cells, each cell synchronously transmits the same signal (the same data) in the same MBSFN subframe.

The logical channels used for SC-PTM transmission are a Single Cell Multicast Traffic Channel (SC-MTCH) and a Single Cell Multicast Control Channel (SC-MCCH), and the transport channel used for SC-PTM transmission is a Downlink Shared Channel (DL-SCH). The SC-PTM transmission is primarily designed for single-cell transmission, and corresponds to broadcast or multicast data transmission on a cell-by-cell basis. The physical channels used for SC-PTM transmission are a Physical Downlink Control Channel (PDCCH) and a Physical Downlink Control Channel (PDSCH), and enables dynamic resource allocation.

Although an example will be mainly described below in which the MBS is provided using a scheme same as, and/or similar to, the SC-PTM transmission scheme, the MBS may be provided using the MBSFN transmission scheme. An example will be mainly described in which the MBS is provided using multicast. Accordingly, the MBS may be interpreted as multicast. Note that, the MBS may be provided using broadcast.

MBS data refers to data provided by the MBS, an MBS control channel refers to the MCCH or SC-MCCH, and an MBS traffic channel refers to the MTCH or SC-MTCH. However, the MBS data may be transmitted in unicast. The MBS data may be referred to as MBS packets or MBS traffic.

The network can provide different MBS services for respective MBS sessions. The MBS session is identified by at least one of Temporary Mobile Group Identity (TMGI) and a session identifier, and at least one of these identifiers is referred to as an MBS session identifier. Such an MBS session identifier may be referred to as an MBS service identifier or a multicast group identifier.

The MBS session includes a broadcast session and a multicast session.

The broadcast session is a session for delivering a broadcast service. A broadcast service provides a service to every UE 100 within a particular service area for an application not requiring highly reliable QoS. The broadcast service is available by the UE 100 in all RRC states (RRC idle state, RRC inactive state, and RRC connected state).

The multicast session is a session for delivering a multicast service. The multicast service provides a service to a group of UEs 100 joining a multicast session for an application requiring highly reliable QoS. The multicast service is mainly available by the UE 100 in the RRC connected state. In the multicast service, MBS data is transmitted in a multicast manner. Such MBS data is referred to as multicast data. In the multicast service, the gNB 200 transmits the same multicast data to a plurality of UEs 100 belonging to a UE 100 group by using the same radio resources.

The UE 100 needs to transition to the RRC connected state in order to receive multicast data.

Operation in which the UE 100 transitions from the RRC idle state to the RRC connected state is referred to as RRC Connection establishment. Operation in which the UE 100 transitions from the RRC inactive state to the RRC connected state is referred to as RRC Connection resume. When determining to perform the RRC Connection establishment or the RRC Connection resume, the UE 100 accesses the gNB 200 through a random access procedure.

A common random access procedure includes Msg1 (Message 1) from the UE 100 to the gNB 200, Msg2 (Message 2) from the gNB 200 to the UE 100, Msg3 (Message 3) from the UE 100 to the gNB 200, Msg4 (Message 4) from the gNB 200 to the UE 100, and Msg5 (Message 5) from the UE 100 to the gNB 200. In the case of a two-step random access procedure, Msg1 and Msg3 are integrated into one message (MsgA), and Msg2 and Msg4 are integrated into one message (MsgB).

Msg1 is a random access preamble from the UE 100 to the gNB 200. Msg2 is a random access response from the gNB 200 to the UE 100.

In the case of the RRC Connection establishment, the UE 100 transmits an RRC Setup Request message in Msg3. The gNB 200 transmits an RRC Setup message in Msg4. The UE 100 transitions from the RRC idle state to the RRC connected state upon reception of the RRC Setup message. After transitioning to the RRC connected state, the UE 100 transmits an RRC Setup Complete message in Msg5.

In the case of the RRC Connection resume, the UE 100 transmits an RRC Resume Request message in Msg3. The gNB 200 transmits an RRC Resume message in Msg4. The UE 100 transitions from the RRC inactive state to the RRC connected state upon reception of the RRC Resume message. After transitioning to the RRC connected state, the UE 100 transmits an RRC resume Complete message in Msg5.

In the random access procedure, the gNB 200 can reject access from the UE 100. When the gNB 200 rejects access from the UE 100, the gNB 200 transmits a message indicating rejection of access from the UE 100 in Msg4. Such a message is an RRC Reject message in the case of the RRC Connection establishment and is an RRC Resume Reject message in the case of the RRC Connection resume.

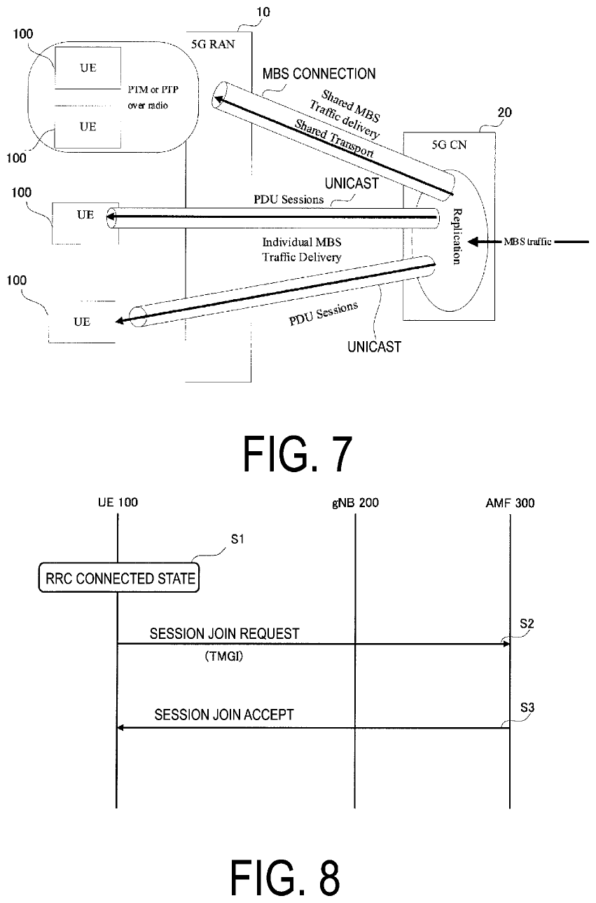

FIG. 7 is a diagram illustrating a delivery method of the MBS data according to an embodiment.

As illustrated in FIG. 7, the MBS data (MBS traffic) is delivered from a single data source (application service provider) to a plurality of UEs. The 5G CN (5G) 20, which is a 5 GC core network, receives the MBS data from the application service provider and performs replication of the MBS data to deliver the resultant.

From the perspective of the 5 GC 20, two delivery methods are possible: shared MBS data delivery (shared MBS traffic delivery) and individual MBS data delivery (individual MBS traffic delivery).

In the shared MBS data delivery, a connection is established between the NG-RAN 10 that is a 5G radio access network (5G RAN) and the 5 GC 20 to deliver the MBS data from the 5 GC 20 to the NG-RAN 10. Such a connection (a tunnel) is hereinafter referred to as an “MBS connection”.

The MBS connection may be referred to as a shared MBS traffic delivery connection or a shared transport. The MBS connection terminates at the NG-RAN 10 (i.e., the gNB 200). The MBS connection may correspond to an MBS session on a one to-one basis.

The gNB 200 selects a transmission scheme either of Point-to-Point (PTP: unicast) or Point-to-Multipoint (PTM: multicast or broadcast) at the discretion of the gNB 200, and transmits the MBS data to the UE 100 through the selected transmission scheme.

On the other hand, in the individual MBS data delivery, a unicast session is established between the NG-RAN 10 and the UE 100 to individually deliver the MBS data from the 5 GC 20 to the UE 100. Such unicast may be referred to as a PDU session. The unicast (PDU session) terminates at the UE 100.

Multicast Session Join Procedure

FIG. 8 is a diagram illustrating a multicast session join procedure according to an embodiment.

As illustrated in FIG. 8, in Step S1, the UE 100 is in the RRC connected state.

In Step S2, the UE 100 transmits a Session Join Request message to the AMF 300 (core network apparatus). The Session Join Request message includes session identification information (e.g., TMGI, session identifier, or group RNTI) for identifying a multicast session in which the UE 100 is interested. The Session Join Request message is a NAS message and is transmitted to the AMF 300 via the gNB 200.

In Step S3, the AMF 300 transmits a Session Join Accept message for accepting session joining to the UE 100. The Session Join Accept message is a NAS message and is transmitted to the UE 100 via the gNB 200. The Session Join Accept message includes permission information indicating permission to receive multicast data. The UE 100 receiving the Session Join Accept message recognizes that reception of the multicast data in the multicast session in which the UE 100 is interested is permitted.

After receiving the Session Join Accept message, the UE 100 may transition to the RRC idle state or the RRC inactive state before the multicast session starts. Once the multicast session starts, the UE 100 may transition to the RRC connected state to receive the multicast data.

### First Embodiment

A first embodiment is an embodiment relating to a random access procedure for multicast data reception.

As described above, the multicast service is available by the UE 100 in the RRC connected state. Thus, the UE 100 in the RRC idle state or the RRC inactive state needs to transition to the RRC connected state through a random access procedure to receive multicast data from the gNB 200.

In the random access procedure, the gNB 200 can reject access from the UE 100. For example, when the amount of radio resources available in the gNB 200 is small (when a value indicating the amount of available radio resources is equal to or less than a predetermined threshold value), the gNB 200 rejects access from a new UE 100 in order to keep radio resources to be allocated to the UE 100 already under control of the gNB 200. The gNB 200 may reject access from the UE 100 for reasons such as a high load level and a high congestion level.

On the other hand, when the gNB 200 has already transmitted multicast data, the multicast data is transmitted to the plurality of UEs 100 using the same radio resources, and thus even when the number of the UEs 100 receiving the multicast data increases, it is highly likely that the amount of radio resources available in the gNB 200 does not decrease, and it is also highly likely that the load level and the congestion level of the gNB 200 do not increase. Thus, in such a case, from the viewpoint of effective utilization of radio resources, the gNB 200 preferably do not reject the UE 100 accessing the gNB 200 for multicast data reception.

However, in the existing specifications, no means is available for the gNB 200 to determine whether the UE 100 accesses the gNB 200 for multicast data reception. The first embodiment is an embodiment for solving such a problem.

In the first embodiment, the UE 100 transmits predetermined information to the gNB 200 in the random access procedure. The predetermined information indicates that the UE 100 accesses the gNB 200 for multicast data reception from the gNB 200.

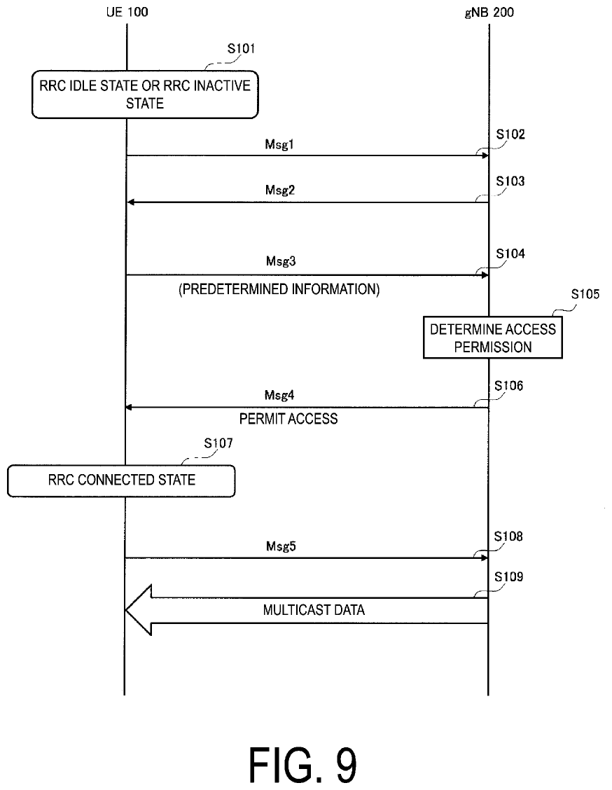

FIG. 9 is a diagram illustrating an operation example according to the first embodiment.

As illustrated in FIG. 9, in Step S101, the UE 100 is in the RRC idle state or the RRC inactive state in the cell of the gNB 200. The UE 100 may start Step S101 after the multicast session join procedure.

When determining to receive multicast data from the gNB 200, the UE 100 starts a random access procedure with the gNB 200 in Step S102. In Step S102, the UE 100 transmits a random access preamble (Msg1) to the gNB 200.

In Step S103, the UE 100 receives a random access response (Msg2) from the gNB 200.

In Step S104, the UE 100 transmits Msg3 including predetermined information to the gNB 200. The predetermined information indicates that the UE 100 accesses the gNB 200 for multicast data reception from the gNB 200. When the UE 100 is in the RRC idle state in Step S101, Msg3 is an RRC Setup Request message, and when the UE 100 is in the RRC inactive state in Step S101, Msg3 is an RRC Resume Request message.

When the Step S101 starts after the multicast session join procedure, the UE 100 may transmit session identification information (for example, TMGI, session identifier, or group RNTI) for identifying an accepted multicast session, together with the predetermined information. When the Step S101 starts before the multicast session join procedure starts and when the RRC connection is for performing the multicast session join procedure, the predetermined information may be notified.

When Msg3 is an RRC Setup Request message, the UE 100 may transmit the predetermined information by using an existing information element called EstablishmentCause in the RRC Setup Request message. The EstablishmentCause is an information element indicating a cause for establishing the RRC connection. For example, the UE 100 sets the value of the EstablishmentCause to “multicast access” and transmits the RRC Setup Request message. The gNB 200 that has received the EstablishmentCause with the value set to “multicast access” recognizes that the UE 100 requests RRC Connection establishment with the gNB 200 for multicast data reception. The UE 100 may transmit the predetermined information by using a new information element in the RRC Setup Request message. The new information element is an information element different from the EstablishmentCause.

When Msg3 is an RRC Resume Request message, the UE 100 may use an existing information element called resumeCause in the RRC Resume Request message. The resumeCause is an information element indicating a cause for resuming the RRC connection. For example, the UE 100 sets the value of the resumeCause to “multicast access” and transmits the RRC Resume Request message. The gNB 200 that has received the resumeCause with the value set to “multicast access” recognizes that the UE 100 requests RRC Connection resume with the gNB 200 for multicast data reception. The UE 100 may transmit the predetermined information by using a new information element in the RRC Resume Request message. The new information element is an information element different from the resumeCause.

In Step S105, the gNB 200 determines whether to permit access from the UE 100 based on the predetermined information. For example, when Msg3 from the UE 100 includes the predetermined information and the gNB 200 transmits multicast data, the gNB 200 determines to permit the UE 100. When the gNB 200 receives the session identification information together with the predetermined information in Step S104, the gNB 200 determines whether to permit access from the UE 100 also considering the session identification information in Step S105. For example, when the multicast session identified by the session identification information matches the multicast session to which the multicast data transmitted by the gNB 200 belongs, the gNB 200 determines to permit access from the UE 100. On the other hand, when the multicast session identified by the session identification information does not match the multicast session to which the multicast data transmitted by the gNB 200 belongs, the gNB 200 determines not to permit (i.e., reject) access from the UE 100.

When the gNB 200 determines to permit access from the UE 100 in Step S105, the UE 100 receives, from the gNB 200, Msg4 (the above-described RRC Setup message or RRC Resume message) indicating access permission in Step S106.

In Step S107, the UE 100 transitions to the RRC connected state.

In Step S108, the UE 100 transmits Msg5 (the above-described RRC Setup Complete message or RRC Resume Complete message).

In Step S109, the UE 100 receives the multicast data from the gNB 200.

In the first embodiment, the UE 100 may transmit the predetermined information by using Msg1. In this case, the UE 100 receives, from the gNB 200, information indicating a special Physical Random Access Channel (PRACH) resource to be used at the time of access for multicast data reception and transmits a random access preamble using the special PRACH resource. When receiving, from the UE 100, the random access preamble transmitted using the special PRACH resource, the gNB 200 recognizes that the UE 100 accesses the gNB 200 for multicast data reception. The information indicating the special Physical Random Access Channel (PRACH) resource is included and transmitted in a System Information Block (SIB) to be broadcast by the gNB 200.

In the first embodiment, the UE 100 may transmit the predetermined information by using Msg5. The UE 100 may transmit the session identification information together with the predetermined information by using Msg5. The gNB 200 may perform mobility control (e.g., handover) of the UE 100 based on the information received by using Msg5.

Msg3, Msg4 and Msg5 in the first embodiment may be used for RRC connection reestablishment. In this case, Msg3 is RRC Reestablishment Request, Msg4 is RRC Reestablishment, and Msg5 is RRC Reestablishment Complete. In this case, in Step S101, the UE 100 is in the RRC connected state and is in a state of detecting a Radio Link Failure (RLF).

In the first embodiment, the predetermined information may indicate that the UE 100 does not transmit or receive unicast data or that the UE 100 does not transmit data. The gNB 200 receiving such predetermined information can recognize that it is unlikely that the amount of radio resources available in the gNB 200 decreases by permitting the UE 100.

In the first embodiment, an example has been described in which the identification information is notified through the four-step random access procedure. However, a two-step random access procedure may be adopted. In the two-step random access procedure, Msg1 and Msg3 are transmitted as MsgA, and Msg2 and Msg4 are transmitted as MsgB. Thus, when the identification information is notified in the two-step random access procedure, the identification information may be transmitted using MsgA.

### Second Embodiment

The second embodiment is an embodiment relating to operation of the NAS layer of the UE 100 before the random access procedure for multicast data reception starts.

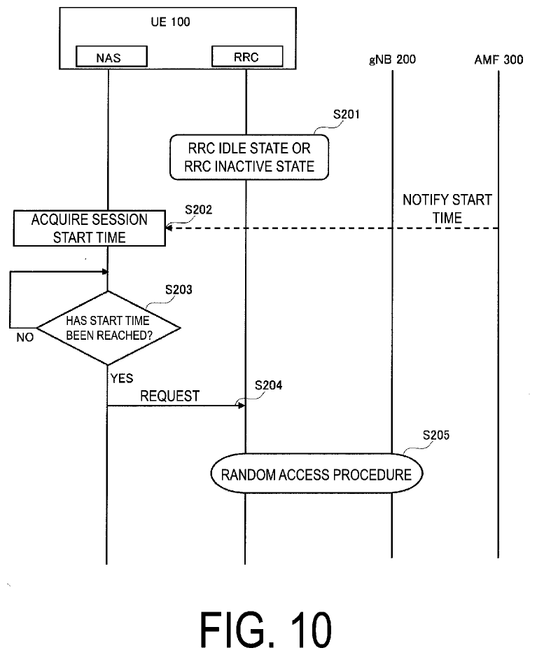

FIG. 10 is a diagram illustrating an operation example according to the second embodiment.

As illustrated in FIG. 10, in Step S201, the UE 100 is in the RRC idle state or the RRC inactive state in the cell of the gNB 200. The UE 100 may start Step S201 after the multicast session join procedure.

In Step S202, the NAS layer of the UE 100 acquires a start time of a multicast session in which the UE 100 is interested. The NAS layer may acquire the start time through notification from the AMF 300. The NAS layer may acquire the start time from User Service Description (USD) stored in the UE 100 in advance. The user service information is information of an application layer (service layer). The user service information includes, for each MBS service, at least one selected from the group consisting of an MBS service identifier (e.g., TMGI), a start time and an end time of the MBS session, a frequency, and an MBMS service area identifier.

In Step S203, the NAS layer of the UE 100 determines whether the start time has been reached. When determining that the start time has been reached (YES in S203), the NAS layer provides the RRC layer of the UE 100 with a request that the UE 100 access the gNB 200 in Step S204. When Step S201 starts after the multicast session join procedure, the NAS layer may provide, together with the request, session identification information for identifying an accepted multicast session.

In Step S205, the UE 100 (lower layers such as the RRC layer, MAC layer, and PHY layer) performs a random access procedure with the gNB 200. In the random access procedure, the UE 100 may transmit the predetermined information in the first embodiment.

After transitioning to the RRC connected state through the random access procedure, the UE 100 receives the multicast data from the gNB 200.

### Variation 1 of Second Embodiment

Operation of Variation 1 of the second embodiment will be described focusing on differences from that of the second embodiment. In Variation 1, the NAS layer provides a request to the RRC layer before the start time is reached.

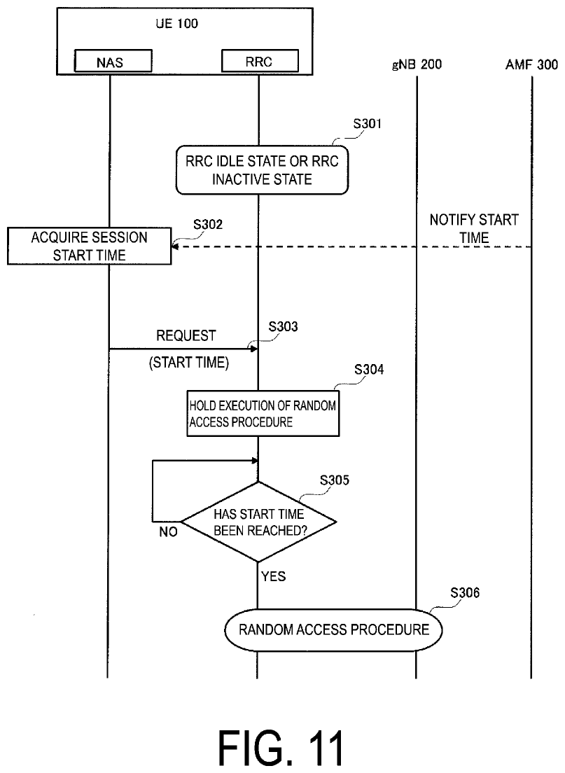

FIG. 11 is a diagram illustrating operation according to Variation 1 of the second embodiment.

Operation in Step S301 to Step S302 is the same as, and/or similar to, the operation in Step S201 to Step S202.

In Step S303, the NAS layer of the UE 100 provides the RRC layer of the UE 100 with a request for the UE 100 to access the gNB 200 before the start time is reached. For example, the NAS layer provides the request when permission is obtained in the multicast session join procedure. The NAS layer provides the RRC layer with information indicating the start time together with the request.

In Step S304, the lower layers of the UE 100 hold execution of a random access procedure.

In Step S305, the lower layers of the UE 100 determine whether the start time has been reached. When determining that the start time has been reached (YES in S305), the lower layers perform the random access procedure in Step S306.

### Variation 2 of Second Embodiment

Operation of Variation 2 of the second embodiment will be described mainly focusing on differences from that of Variation 1.

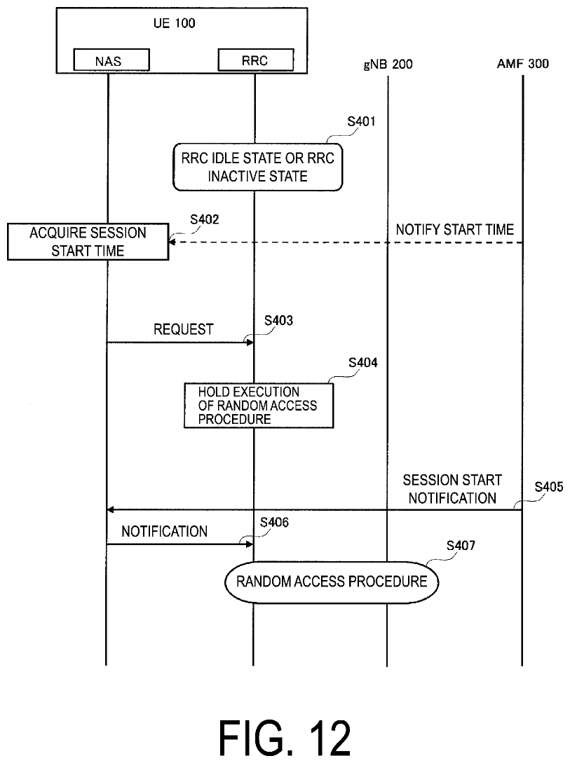

FIG. 12 is a diagram illustrating operation according to Variation 2 of the second embodiment.

Operation in Step S401 to Step S404 is the same as, and/or similar to, the operation in Step S301 to Step S304. However, in Step S403, the NAS layer of the UE 100 does not need to notify the RRC layer of the start time.

In Step S405, the NAS layer of the UE 100 receives a session start notification from the AMF 300. The session start notification is a notification indicating that a multicast session starts. The session start notification may be included in a paging message. The session start notification may include session identification information (e.g., TMGI, session identifier, or group RNTI) of the multicast session to be started.

In Step S406, the NAS layer of the UE 100 notifies the RRC layer that the multicast session starts. When the session start notification includes the session identification information, the NAS layer also notifies the RRC layer of the session identification information.

In Step S407, the UE 100 (lower layers such as the RRC layer, MAC layer, and PHY layer) starts a random access procedure in response to the notification.

Here, when receiving the session identification information together with the request in Step S403, the RRC layer of the UE 100 may compare the session identification information with the session identification information included in the session start notification received in Step S406 and start the random access procedure when both pieces of information match each other.

In Variation 2, the RRC layer of the UE 100 may receive the session start notification in Step S405. The gNB 200 may broadcast the session start notification using an SIB. For example, the session start may be notified by adding, to the SIB, the session identification information (e.g., TMGI, session identifier, or group RNTI) of the multicast session to be started. Alternatively, the notification may be performed by RAN paging. The RAN paging may include the session identification information of the session to be started. The UE 100 (lower layers such as the RRC layer, MAC layer, and PHY layer) starts the random access procedure in response to the notification.

In the second embodiment described above, an example in which the UE 100 receives the multicast data has been described. As another example, the UE 100 is interested in receiving broadcast data (MBS data transmitted in a broadcast manner). When the start time of the broadcast session has been reached, the NAS layer of the UE 100 notifies the RRC layer of the arrival of the start time. In response to the notification, the RRC layer starts receiving an SIB for MBS and/or an MBS control channel.

### OTHER EMBODIMENTS

The embodiments described above and the variations of the embodiments can not only be separately and independently implemented, but can also be implemented in combination of two or more of the embodiments.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure.

### Supplementary Note

### Introduction

In RAN #88, revised work items have been approved that are related to NR multicast broadcast service (MBS).

It has been agreed in RAN2 #112-e that two delivery modes of the MBS are to be introduced as follows.

In the case of Rel-17, R2 specifies the following two modes.

1: One delivery mode for high QoS (reliability, delay) requirements available in the connected state (the UE can be switched to another state when no data reception is present, but this is not determined yet).

2: One delivery mode for “low” QoS requirements. The UE can also receive data in the inactive/idle state (details are not determined yet).

R2 assumes that Delivery mode 1 is only used for multicast sessions (in the case of R17).

R2 assumes that Delivery mode 2 is used for broadcast sessions.

The applicability of Delivery mode 2 to multicast sessions needs further study.

No data: When no ongoing data is present in a multicast session, the UE can remain in the RRC connected state. Further study is needed in the other cases.

For Delivery mode 2, an overview of the MBS configuration has been additionally agreed upon as follows.

The UE receives the MBS configuration (in the case of the broadcast/Delivery mode 2) through the BCCH and/or MCCH (TBD). This can be received in the idle/inactive mode. Further study is needed for the connected mode (dependent on the UE capacity, such as a location where the service is provided). The notification mechanism is used to notify a change in the MBS control information.

In RAN2 #113-e, the details of Delivery mode 2 have been agreed upon as follows. Both the UE in the idle/inactive state and the UE in the connected mode can receive the MBS service transmitted in NR MBS Delivery mode 2 (broadcast service already agreed upon, others undetermined). Whether the UE in the connected mode can receive this depends on the network provisioning of the service (e.g., which frequency), the configuration of the UE connected mode, and the function of the UE.

The two-step based approach (BCCH and MCCH) adopted by the LTE SC-PTM is reused to transmit the PTM configuration in NR MBS Delivery mode 2.

It is assumed that the PTM configuration of NR MBS Delivery mode 2, i.e., the broadcast-based method, can be received by reusing the LTE SC-PTM mechanism of the connected UE.

It is assumed that the MCCH change notification mechanism is used to notify the MCCH configuration change due to session start in NR MBS Delivery mode 2 (in other cases, further study is needed).

It is assumed that the MBS interest indication is supported by the UE in the connected mode of the broadcast service (it is usually assumed that no mandatory network requirement exists and the network action depends on the network).

The MBS interest indication is not supported by the UE in the idle/inactive mode in NRMBS Delivery mode 2.

For the purpose of service continuity, it is assumed that some pieces of information can be provided for NR MBS Delivery Mode 2 (further study is needed and, for example, reconsideration is needed based on the progress of other groups, e.g., USD and SAI/TMGI).

Whether to support the UE recognition of the MBS service on a frequency basis for the service continuity in NR MBS Delivery mode 2 needs further study (i.e., reuse of the LTE SC-PTM mechanism).

The support of frequency prioritization during cell reselection for the service continuity in NR MBS Delivery mode 2 needs further study (i.e., reuse of the LTE SC-PTM mechanism).

P2: Whether the UE receiving multicast data can be released to the RRC inactive/idle state and continue receiving the multicast data is postponed. In future discussion, the RRC needs to be limited to the inactive state.

In this supplementary note, the control plane aspect of the NR MBS is considered in view of the LTE eMBMS mechanism and the latest RAN2 agreement.

### Discussion

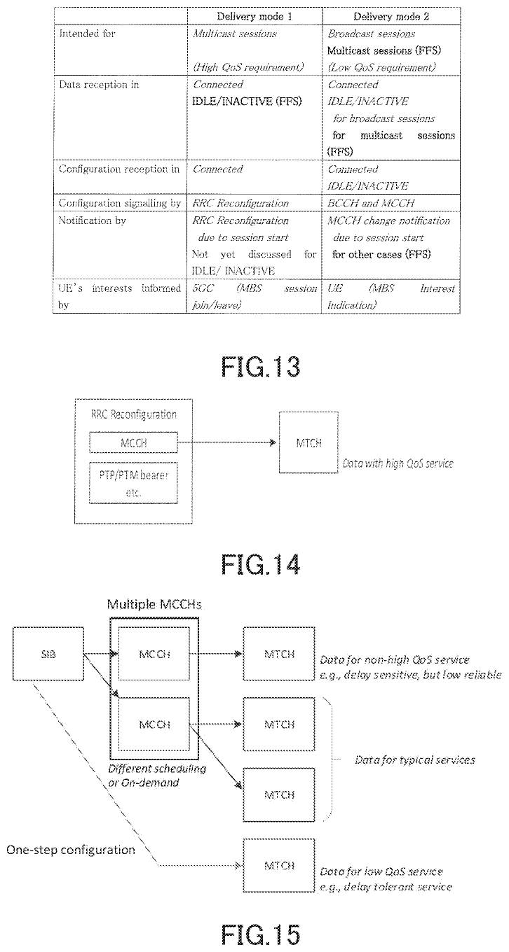

At this point, according to the RAN2 agreement cited in Section 1 and the report of the LS reply to SA2, the characteristics of the two delivery modes can be summarized in FIG. 13.

### Delivery Mode 1 Configuration

In Delivery mode 1, data reception in the RRC connected state is mainly considered, but the details of the configuration aspect thereof are not yet agreed upon. Considering that Delivery mode 1 is used for high QoS services, Delivery mode 1 needs to involve, for example, the PTP/PTM split bearer and/or lossless handover. Since whether these UE-specific configurations are provided through the MCCH is pointless, it is very easy that the RRC reconfiguration needs to be used for the configuration of Delivery mode 1. In the LS reply to SA2, it has been actually confirmed that the RRC reconfiguration is used for the MBS configuration and notification due to session start.

Observation 1: For Delivery mode 1, the RRC reconfiguration is used for the MBS configuration and notification due to session start.

On the other hand, the WID clearly indicates that the RRC connected state and the RRC idle/inactive state need to have the maximum commonalities in terms of the MBS configuration. However, RAN2 has agreed to separate delivery modes of multicast and broadcast sessions.

Changes are specified that are needed to enable the UE in the RRC idle/RRC inactive state to receive PTM transmission in order to maintain the maximum commonalities between the RRC connected state and the RRC idle/RRC inactive state for the PTM reception configuration.

Even when the RRC messages of these delivery modes are different, the IE and structure of the MBS configuration need to be adjusted as much as possible between the two delivery modes to achieve the purpose of the WID, as pointed out in the discussion of RAN2 #112-e. For example, the RRC reconfiguration of Delivery mode 1 includes information specific to Delivery mode 1 such as the PTP/PTM split bearer and handover related information, in addition to the MTCH scheduling information, which is a block common to Delivery mode 2. Thus, the details need further study at this point.

Proposal 1: RAN2 needs to agree to aim for the maximum commonalities between the two delivery modes from the viewpoint of the MBS configuration, for example, by using the common structure and IE.

It needs to be noted that the “MCCH” in FIG. 14 refers only to the MTCH scheduling information, i.e., the MTCH configuration associated with the MBS session information. In the case of Delivery mode 1, adjacent cell information is not necessary.

However, whether the UE can be released to the idle/inactive state when no ongoing data is present for the multicast session still needs further study. In other words, whether the UE in the idle/inactive state can receive the MBS data via Delivery mode 1 still needs further study. As agreed upon by RAN2, the baseline is premised on that the UE needs to remain in the RRC connected state for Delivery mode 1, that is, for the multicast session, which requires high QoS. However, other/exceptional cases are worth studying.

In e-mail discussions, some companies have pointed out that the network may not be able to keep all of the UEs in the connected state due to congestion. Other several companies have also pointed out that the UE does not need to always remain to be connected for the uplink inactivity, QoS requirements, and/or power consumption of the UE.

The above points may be beneficial for both the network and the UE. However, it is understood that whether/when the UE is released to the inactive state depends on the implementation of the gNB and that whether the UE is released to the idle state depends on the core network. One concern with the MBS data reception in the idle state is that when the gNB releases the UE context (typically only held in the inactive state and not held in the idle state), the controllability of the gNB may be lost. This may be inconsistent with the concept of Delivery mode 1. Thus, it is stated in the agreement of RAN2 #113-e that “it is necessary to limit the RRC to the inactive state in future discussion”. Thus, RAN2 needs to agree that the UE can receive Delivery mode 1 at least in the inactive state.

Proposal 2: For Delivery mode 1, RAN2 needs to agree that the UE can receive the MBS data at least in the RRC inactive state.

When Proposal 2 can be agreed upon, it is not clear how the idle/inactive MBS configuration is provided to the UE. There are three possible options.

Option 1: RRC reconfiguration

The UE in the idle/inactive state continues to employ the MBS configuration provided through the RRC reconfiguration. This option is simple because the UE only reuses the MBS configuration first provided for the RRC connected state. However, part of the UE operation needs to be clarified at the time of transition to the idle/inactive state and/or return to the RRC connected state (such as a method of processing the PTP/PTM split bearer configuration when the configuration is performed).

Option 2: RRC release

The UE in the idle/inactive state employs the MBS configuration provided through the RRC release. This option seems to be simple but may not be efficient, because it is doubtful whether the MBS configuration is different from the MBS configuration previously provided through the RRC reconfiguration.

Option 3: Switching of the delivery mode from Mode 1 to Mode 2

The UE is switched from Delivery mode 1 to Delivery mode 2 before being released to the idle/inactive state. This option is another simple solution since Delivery mode 2 is designed to be able to receive data in all the RRC states as agreed upon by the RAN2. However, it may be expected that packet loss and delay will occur during the switching, for example, due to acquisition of the MCCH.

Each option has advantages and disadvantages, but in our view, Option 1 is slightly preferable in terms of simplicity and efficiency. RAN2 needs to describe a method of providing the UE with the Delivery mode 1 configuration for data reception in the idle/inactive state, which includes the above options but is not limited thereto.

Proposal 3: When Proposal 2 is agreed upon, RAN2 needs to discuss how the Delivery mode 1 configuration for data reception in the inactive state is provided to the UE.

Delivery Mode 2 Configuration

In the LTE SC-PTM, configurations are provided using two messages, i.e., SIB 20 and SC-MCCH. The SIB 20 provides SC-MCCH scheduling information. The SC-MCCH provides SC-MTCH scheduling information including the G-RNTI and the TMGI, and neighbor cell information. It has been agreed to reuse the same mechanism for the NR MBS.

The NR MBS is expected to support various types of use cases described in the WID. The NR MBS needs to be appropriately designed for a variety of requirements ranging from delay sensitive applications such as mission critical applications and V2X to delay tolerant applications such as IoT, in addition to the other aspects of requirements ranging from lossless applications such as software delivery to UDP type streaming such as IPTV. Some of these services may be covered by Delivery mode 2, while other services with “high QoS requirements” require Delivery mode 1. In this sense, it is beneficial for the gNB to be able to choose use of Delivery mode 2 for multicast sessions.

This problem has been left for further study from RAN2 #112-e to RAN2 #113-e, but in general there seems to be no technical reason to impose limitations from our point of view.

Proposal 4: RAN2 needs to agree that Delivery mode 2 can be used for multicast sessions in addition to broadcast sessions.

The control channel in Delivery mode 2 needs to be designed in consideration of the flexibility and resource efficiency of the control channel in view of Proposal 4. Otherwise, for example, when a delay tolerant service and a delay sensitive service are configured together in one control channel, more signaling overhead may occur. This requires the control channel to be scheduled frequently in order to meet the delay requirements from the delay sensitive service.

An object A of the SA2 SI relates to enabling of general MBS services via 5 GS, and specified use cases capable of benefiting from this function include (but are not limited to) public safety, mission critical cases, V2X applications, transparent IPv4/IPv6 multicast delivery, and IPTV, and include software delivery through wireless communications, group communications, and via IoT applications.

Observation 2: The control channel for Delivery mode 2 needs to be flexible and resource efficient with respect to various types of use cases.

One possibility is to study whether configuration channels need to be separated in different use cases, as illustrated in FIG. 15. For example, one MCCH frequently provides a delay sensitive service, and another MCCH infrequently provides a delay tolerant service. The LTE SC-PTM is limited in that one cell includes only one SC-MCCH. However, considering that more use cases are assumed in NR MBS Delivery mode 2 than LTE, such limitation needs to be eliminated. When a plurality of MCCHs are allowed within a cell, each MCCH includes a different scheduling configuration such as a repetition period which can be optimized for a specific service. A method in which the UE identifies the MCCH providing a service to a target service needs further study.

Proposal 5: For Delivery mode 2, RAN2 needs to consider whether the plurality of MCCHs not supported in LTE are supported in a cell.

A new paradigm of NR is support for on-demand SI transmission. This concept may be reused for the MCCH in Delivery mode 2, i.e., on-demand MCCH. For example, the MCCH for delay tolerant services is provided on demand, thus enabling optimization of resource consumption for signaling. Naturally, the network includes another option for providing the MCCH periodically. That is, it is not on-demand, such as delay sensitive services.

Proposal 6: For Delivery mode 2, RAN2 needs to discuss an option when the MCCH is provided on demand, which is not supported by LTE.

As another possibility, merging these messages, i.e., one-step configuration as illustrated in FIG. 15, may be studied further. For example, the SIB provides MTCH scheduling information directly, i.e., without the MCCH. Delay tolerant services and optimization of power-sensitive UEs are provided. For example, the UE can request the SIB (on demand), and the gNB can start providing the SIB and the corresponding service after requests from the plurality of UEs. These UEs do not need to monitor the repeatedly broadcast MCCH.

Proposal 7: For Delivery mode 2, RAN2 needs to discuss an option when multicast reception without the MCCH is supported (i.e., one-step configuration). For example, the SIB provides MTCH scheduling information directly.

Introduction of the MCCH change notification has been agreed upon. This is assumed to be the same as, and/or similar to, notification of the LTE SC-PTM. Through at least session start, the UE is notified of the MCCH change.

According to the latest LTE specifications, the SC-MCCH change notification is notification in which “regarding a change of the first subframe available for the SC-MCCH transmission in the repetition period, a UE other than a BL UE, a UE in a CE, or a NB-IoT UE is notified of the change when the network changes (part of) the SC-MCCH information”, and it may be interpreted that the SC-MCCH change notification does not need to be limited to some extent at session start.

When no MCCH change notification is provided during the MBS session, the UE needs to always decode the MCCH at every MCCH change boundary to check whether the MCCH is updated. This is inefficient in terms of UE power consumption, compared to the case of decoding only the MCCH change notification. Thus, the MCCH change notification needs to be provided not only at the session start but also whenever the configuration is changed.

Proposal 8: For Delivery mode 2, RAN2 needs to discuss whether the MCCH change notification is provided each time the MCCH information is changed.

Interest Indication/Count

In the LTE eMBMS, in order for the network to perform appropriate determination of MBMS data delivery including MBMS session start/stop, two types of methods of collecting a service that the UE is receiving/interested in are specified, i.e., the MBMS interest indication (MII) and MBMS count. The MII triggered by the UE includes information related to a target MBMS frequency, a target MBMS service, an MBMS priority, and an MBMS reception-only mode (ROM). A count response triggered by the network via a count request for a specific MBMS service includes information related to a target MBSFN area and a target MBMS service.

These methods have been introduced for various purposes. The MII is mainly used by the network to enable the UE to continue to receive the target service during connection. In contrast, the count is used to enable the network to determine whether a sufficient number of UEs are interested in receiving the service.

Observation 3: In the LTE eMBMS, two types of UE assistance information are introduced for different purposes. For example, the MBMS interest indication for eNB scheduling, and the MBMS count for session control of the MCE are introduced.

For the NR MBS, the MBS interest indication is agreed to be supported in the RRC connected state but not in the idle/inactive state. Based on this, it is worthwhile to study function enhancement, in addition to the LTE eMBMS. In the LTE eMBMS, even when most of the UEs receive broadcast services in the RRC idle state, information of neither the MII nor count can be collected from the UEs in the idle state. To our understanding, this is one remaining problem that the LTE eMBMS has from the viewpoint of session control and resource efficiency.

In the NR MBS, the same problem may occur in the UE in the idle/inactive state, i.e., in Delivery mode 2 of broadcast sessions. For example, the network does not recognize whether the UE in the idle/inactive state is not receiving/interested in broadcast services. Thus, the network may continue to provide PTM transmission even when no UEs are receiving services. When the gNB recognizes interest of the UE in the idle/inactive state, such unnecessary PTM transmission needs to be avoided. Conversely, when the PTM stops while the UEs in the idle/inactive state receiving services are still present, many UEs may simultaneously request connection, which is also undesirable.

Accordingly, it is worthwhile to study whether to introduce a mechanism for collecting the UE assistance information, specifically the MBMS count, from the UE in the idle/inactive state. Needless to say, it is desirable that the UEs in the idle/inactive state be capable of reporting information without transitioning to the RRC connected state. For example, this may be achieved when the PRACH resource partitioning associated with the MBS service is introduced to such a report.

It is noted that no MCE is present in the NR MBS. This means that the MCE function is integrated in the gNB. In this sense, it is RAN3 that determines whether the count is required in the NRMBS, regardless of what RAN2 has determined from the viewpoint of the network interface.

Proposal 9: RAN2 needs to discuss whether the MBS count is introduced and also collected from the UE in the idle/inactive state.

1. A communication control method used in a mobile communication system providing a multicast broadcast service (MBS) from a base station to a user equipment, the communication control method comprising:
by the user equipment, transmitting predetermined information to the base station in a random access procedure, wherein
the predetermined information indicates that the user equipment accesses the base station to receive multicast data from the base station.

2. The communication control method according to claim 1, wherein
the transmitting of the predetermined information comprises transmitting a message comprising the predetermined information to the base station, and
the message is Message 3 or Message 5 in the random access procedure.

3. The communication control method according to claim 1, further comprising:
by the user equipment, receiving, from the base station, information indicating a Physical Random Access Channel (PRACH) resource to be used when accessing the base station and thus receiving the multicast data, wherein
the predetermined information is a random access preamble transmitted by using the PRACH resource.

4. The communication control method according to claim 2, wherein
the transmitting of the predetermined information comprises transmitting the message comprising the predetermined information to the base station when the user equipment accesses the base station and does not transmit data.

5. The communication control method according to claim 2, wherein
the message is an RRC Setup Request message,
the RRC Setup Request message comprises an information element indicating a connection cause, and
the transmitting of the predetermined information comprises transmitting the RRC Setup Request message comprising the predetermined information as the information element.

6. The communication control method according to claim 1, further comprising:
by the base station, determining, based on the predetermined information, whether to permit establishment or resumption of Radio Resource Control (RRC) connection between the user equipment and the base station.

7. The communication control method according to claim 1, further comprising:
by the user equipment, receiving, from a core network apparatus, permission information related to permission to receive the multicast data, wherein
the transmitting of the predetermined information comprises transmitting the predetermined information after receiving the permission information.

8. A communication control method used in a mobile communication system providing a multicast broadcast service (MBS) from a base station to a user equipment, the communication control method comprising:
by a Non-Access Stratum (NAS) layer of the user equipment, acquiring a start time of an MBS session; and
by the NAS layer, providing, based on the start time, a lower layer located below the NAS layer with a request for the user equipment to access the base station.

9. The communication control method according to claim 8, wherein
the providing of the request comprises, by the NAS layer, providing the request when the start time is reached, and
the communication control method further comprises, by the lower layer, performing a random access procedure with respect to the base station upon reception of the request.

10. The communication control method according to claim 8, wherein
the providing of the request comprises, by the NAS layer, providing the request before the start time is reached, wherein
the communication control method further comprises
by the NAS layer, transmitting, to the lower layer, information indicating the start time, and
by the lower layer, performing a random access procedure with respect to the base station when the start time is reached after reception of the request.

11. The communication control method according to claim 8, wherein
the providing of the request comprises, by the NAS layer, providing the request before the start time is reached, wherein
the communication control method further comprises
by the user equipment, receiving, from a core network apparatus, a notification indicating that the MBS session starts, and
by the lower layer, performing a random access procedure with respect to the base station upon reception of the notification.

12. The communication control method according to claim 8, further comprising:
by the NAS layer, receiving, from a core network apparatus, permission information related to permission to receive multicast data, wherein
the transmitting of the request comprises transmitting the request after receiving the permission information.

13. A user equipment comprising:
a processor configured to perform the communication control method according to claim 1.

14. A network apparatus configured to provide a multicast broadcast service (MBS) to a user equipment, the network apparatus comprising:
a receiver configured to receive from the user equipment in a random access procedure, predetermined information, wherein
the predetermined information indicates that the user equipment accesses the base station to receive multicast data from the base station.
